(19) United States
(12) Patent Application Publication
(10) Pub. No.: US 2025/0022096 A1
(43) Pub. Date: Jan. 16, 2025

(54) GAN-BASED SUPER-RESOLUTION IMAGE PROCESSING METHOD AND APPARATUS, DEVICE, AND MEDIUM

(71) Applicant: BEIJING ZITIAO NETWORK TECHNOLOGY CO., LTD., Beijing (CN)

(72) Inventor: Hang DONG, Beijing (CN)

(21) Appl. No.: 18/714,033

(22) PCT Filed: Nov. 25, 2022
(86) PCT No.: PCT/CN2022/134230

§ 371 Date: May 28, 2024

(30) Foreign Application Priority Data
Nov. 25, 2021 (CN) 202111416020.3

(51) Int. Cl. G06T 3/4053; G06T 5/50; G06V 10/44

(52) U.S. Cl. CPC G06T 3/4053; G06T 5/50; G06V 10/44; G06T 2207/20081; G06T 2207/20221

(57) ABSTRACT

Embodiments of the present disclosure relate to a GAN-based super-resolution image processing method and apparatus, a device, and a medium. The method includes: obtaining a first feature of a positive sample image corresponding to an input sample image and a third feature corresponding to a reference sample image; determining a binary cross entropy (BCE) loss function based on the first feature and the third feature, extracting a fourth feature corresponding to the positive sample image, a fifth feature corresponding to a negative sample image, and a sixth feature corresponding to the reference sample image, and determining a second contrastive learning loss function based on the fourth feature, the fifth feature, and the sixth feature; and training parameters of a generative model based on the BCE loss function and the second contrastive learning loss function to obtain a target super-resolution network, so that super-resolution processing is performed on a test image based on the target super-resolution network to obtain a target super-resolution image.

### CROSS-REFERENCE TO RELATED APPLICATIONS

The present application is a National Stage Entry of International application No. PCT/CN2022/134230 filed on Nov. 25, 2022, based on and claims priority to Chinese Application No. 202111416020.3, filed on Nov. 25, 2021, which are incorporated herein by reference in their entireties.

### TECHNICAL FIELD

The present disclosure relates to the field of image processing technologies, and in particular, to a GAN-based super-resolution image processing method and apparatus, a device, and a medium.

### BACKGROUND ART

The super-resolution processing of an image refers to upscaling resolution of the image, such that a super-resolution image with high resolution can be obtained from an image with low resolution. This technique is often used for image quality enhancement in short video frames and other scenarios.

### SUMMARY OF THE INVENTION

The present disclosure provides a GAN-based super-resolution image processing method and apparatus, a device, and a medium. An embodiment of the present disclosure provides a GAN-based super-resolution image processing method. The method includes: obtaining a positive sample image, a negative sample image, and a reference sample image, where the positive sample image is a ground-truth super-resolution image corresponding to an input sample image, the negative sample image is an image obtained by performing fusion and noise addition on the input sample image and the positive sample image, and the reference sample image is an image output after the input sample image is processed to reduce image quality by a generative model of a generative adversarial network (GAN) to be trained;
extracting a first feature corresponding to the positive sample image and a third feature corresponding to the reference sample image by using a discriminative model of the GAN, separately performing discrimination on the first feature and the third feature to obtain a first score corresponding to the positive sample image and a second score corresponding to the reference sample image, and determining a binary cross entropy (BCE) loss function based on the first score and the second score;
extracting a fourth feature corresponding to the positive sample image, a fifth feature corresponding to the negative sample image, and a sixth feature corresponding to the reference sample image by using a preset network, and determining a second contrastive learning loss function based on the fourth feature, the fifth feature, and the sixth feature, where the second contrastive learning loss function is used for enabling a feature of the reference sample image to be close to a feature of the positive sample image and far away from a feature of the negative sample image; and
training parameters of the generative model by performing backpropagation based on the BCE loss function and the second contrastive learning loss function, to obtain a target super-resolution network, so that super-resolution processing is performed on a test image based on the target super-resolution network to obtain a target super-resolution image.

An embodiment of the present disclosure further provides a GAN-based super-resolution image processing apparatus. The apparatus includes:
a first obtaining module configured to obtain a positive sample image, a negative sample image, and a reference sample image, where the positive sample image is a ground-truth super-resolution image corresponding to an input sample image, the negative sample image is an image obtained by performing fusion and noise addition on the input sample image and the positive sample image, and the reference sample image is an image output after the input sample image is processed to reduce image quality by a generative model of a generative adversarial network (GAN) to be trained;
a second obtaining module configured to extract a first feature corresponding to the positive sample image and a third feature corresponding to the reference sample image by using a discriminative model of the GAN, separately perform discrimination on the first feature and the third feature to obtain a first score corresponding to the positive sample image and a second score corresponding to the reference sample image, and determine a binary cross entropy (BCE) loss function based on the first score and the second score;
a determining module configured to extract a fourth feature corresponding to the positive sample image, a fifth feature corresponding to the negative sample image, and a sixth feature corresponding to the reference sample image by using a preset network, and determine a second contrastive learning loss function based on the fourth feature, the fifth feature, and the sixth feature, where the second contrastive learning loss function is used for enabling a feature of the reference sample image to be close to a feature of the positive sample image and far away from a feature of the negative sample image; and
a third obtaining module configured to train parameters of the generative model by performing backpropagation based on the BCE loss function and the second contrastive learning loss function, to obtain a target super-resolution network, so that super-resolution processing is performed on a test image based on the target super-resolution network to obtain a target super-resolution image.

An embodiment of the present disclosure further provides an electronic device. The electronic device includes: a processor; and a memory configured to store instructions executable by the processor, where the processor is configured to read the executable instructions from the memory, and execute the instructions to implement the GAN-based super-resolution image processing method as provided in the embodiment of the present disclosure.

An embodiment of the present disclosure further provides a computer-readable storage medium having stored thereon a computer program for performing the GAN-based super-resolution image processing method as provided in the embodiment of the present disclosure.

The super-resolution image processing solution provided in the embodiments of the present disclosure includes: obtaining the positive sample image, the negative sample image, and the reference sample image, where the positive sample image is the ground-truth super-resolution image corresponding to an input sample image, the negative sample image is the image obtained by performing fusion and noise addition on the input sample image and the positive sample image, and the reference sample image is the image output after the input sample image is processed to reduce image quality by using the generative model of the generative adversarial network (GAN) network to be trained; extracting the first feature corresponding to the positive sample image and the third feature corresponding to the reference sample image by using the discriminative model of the GAN, separately performing discrimination on the first feature and the third feature to obtain the first score corresponding to the positive sample image and the second score corresponding to the reference sample image, and determining the binary cross entropy (BCE) loss function based on the first score and the second score; extracting the fourth feature corresponding to the positive sample image, the fifth feature corresponding to the negative sample image, and the sixth feature corresponding to the reference sample image by using the preset network, and determining the second contrastive learning loss function based on the fourth feature, the fifth feature, and the sixth feature, where the second contrastive learning loss function is used for enabling the feature of the reference sample image to be close to the feature of the positive sample image and far away from the feature of the negative sample image; and training the parameters of the generative model by performing backpropagation based on the BCE loss function and the second contrastive learning loss function, to obtain the target super-resolution network, so that super-resolution processing is performed on the test image based on the target super-resolution network to obtain the target super-resolution image.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of a GAN-based super-resolution image processing method according to an embodiment of the present disclosure;

FIG. 2 is a schematic diagram of a scenario of obtaining a negative sample image according to an embodiment of the present disclosure;

FIG. 3 is a schematic diagram of another scenario of obtaining a negative sample image according to an embodiment of the present disclosure;

FIG. 4 is a schematic flowchart of another GAN-based super-resolution image processing method according to an embodiment of the present disclosure;

FIG. 5 is a schematic diagram of a super-resolution image processing scenario according to an embodiment of the present disclosure;

FIG. 6 is a schematic flowchart of another GAN-based super-resolution image processing method according to an embodiment of the present disclosure;

FIG. 7 is a schematic flowchart of another GAN-based super-resolution image processing method according to an embodiment of the present disclosure;

FIG. 8 is a schematic diagram of another super-resolution image processing scenario according to an embodiment of the present disclosure;

FIG. 9 is a schematic diagram of another super-resolution image processing scenario according to an embodiment of the present disclosure;

FIG. 10 is a schematic diagram of another super-resolution image processing scenario according to an embodiment of the present disclosure;

FIG. 11 is a schematic diagram of a structure of a super-resolution image processing apparatus according to an embodiment of the present disclosure; and

FIG. 12 is a schematic diagram of a structure of an electronic device according to an embodiment of the present disclosure.

### DETAILED DESCRIPTION OF THE INVENTION

Embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish between different apparatuses, modules, or units, and are not used to limit the sequence or interdependence of functions performed by these apparatuses, modules, or units.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

In the related art, a super-resolution network is employed to process an input image with low resolution to output a super-resolution image with high resolution. The super-resolution network is mainly trained by using a training framework based on generative adversarial networks (GANs). That is, an additional discriminative module is used for discriminating between the super-resolution image generated by the network and a real high-definition image, thereby facilitating the progress of the super-resolution network.

However, when the GAN learns training sample images, especially those with wide input fields, the GAN may learn to discriminate between the super-resolution image and the real high-definition image at a variety of feature levels, thus introducing some complex and rare noise and artifacts, and causing more artifacts and noise to be contained in the generated super-resolution image.

The present disclosure provides a GAN-based super-resolution image processing method and apparatus, a device, and a medium, so as to solve the following problem in the related art: A GAN may use a super-resolution image output by a network and a real high-definition image as inputs for discrimination. However, if there are some complex noise or rare artifacts in the output super-resolution image, a feature extraction layer of a discriminator in the GAN may selectively ignore such “outliers”, such that such noise and artifacts are accepted by the discriminator and introduced into the super-resolution image. Consequently, the generated super-resolution image contains a lot of artifacts and noise, causing reduced image quality.

Specifically, in order to solve the above problem, an embodiment of the present disclosure provides a GAN-based super-resolution image processing method. In this method, a contrastive loss (contrastive learning loss, CR loss) function is introduced into a training process of a discriminative model of a GAN to supervise a feature extraction process of the discriminative model, such that the discriminative model part of the GAN can distinguish between a super-resolution image output by a network and a real high-definition image more easily. Therefore, the discriminative model of the GAN becomes more sensitive to noise and artifacts, and the difficulty of discrimination and training of the GAN is reduced. The method can be applied to a variety of image quality enhancement tasks and GAN-based training frameworks thereof. In sum, supervised training is performed on a feature extraction process of the GAN based on the loss functions, which improves the sensitivity of the discriminative model to noise and artifacts and reduces the difficulty of discrimination and training of the discriminative model, improving the purity of the target super-resolution image on the basis of ensuring the richness of image details of the target super-resolution image output by the target super-resolution network

The method is described below with reference to specific embodiments.

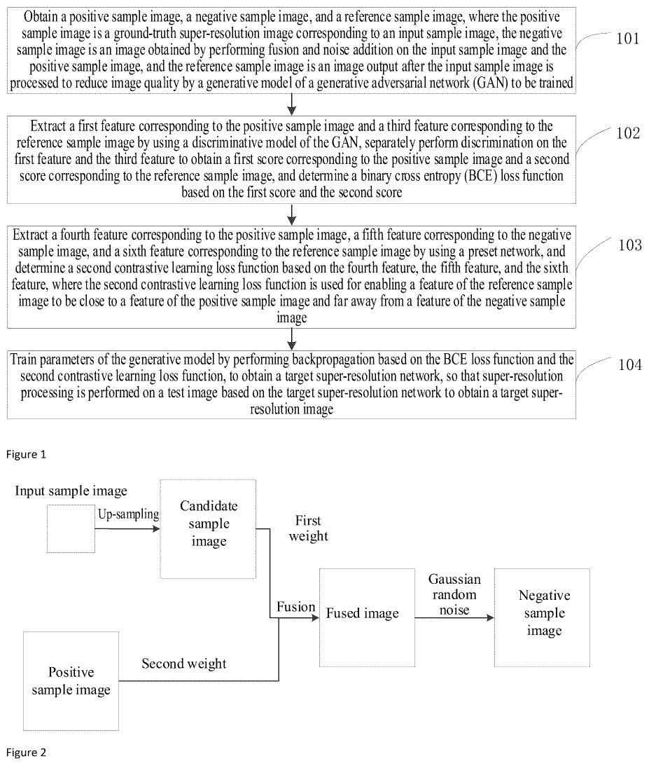

FIG. 1 is a schematic flowchart of a GAN-based super-resolution image processing method according to an embodiment of the present disclosure. The method may be performed by a GAN-based super-resolution image processing apparatus, where the apparatus may be implemented using software and/or hardware and may generally be integrated into an electronic device. As shown in FIG. 1, the method includes the following steps.

Step 101: Obtain a positive sample image, a negative sample image, and a reference sample image, where the positive sample image is a ground-truth super-resolution image corresponding to an input sample image, the negative sample image is an image obtained by performing fusion and noise addition on the input sample image and the positive sample image, and the reference sample image is an image output after the input sample image is processed to reduce image quality by a generative model of a generative adversarial network (GAN) to be trained.

In this embodiment, in order to better simulate real image quality reduction, the ground-truth super-resolution image corresponding to the input sample image is obtained as the positive sample image, and the positive sample image is a real high-definition image. In addition, the image output after the input sample image is processed to reduce image quality by the generative model of the GAN to be trained is obtained as the reference sample image. In addition, the negative sample image corresponding to the input sample image is further obtained. In this way, it is ensured that in the subsequent training process, a distance from the negative sample image is considered to be as large as possible, while a distance from the positive sample image is considered, thereby further improving the training effect.

It should be noted that a method for obtaining the negative sample image varies in different application scenarios, and examples are as follows.

In some embodiments of the present disclosure, because the input sample image, the output reference sample image, and the positive sample image have different sizes, the input sample image is up-sampled to obtain a candidate sample image with the same size as the positive sample image, and then the negative sample image is generated based on the candidate sample image and the positive sample image. Thus, the positive sample image is fused to generate the negative sample image, such that the negative sample image is slightly close to the positive sample image, thereby improving the training difficulty and preventing rapid convergence.

In this embodiment, with reference to FIG. 2, a first weight corresponding to the candidate sample image may be determined, for example, as 0.5, and a second weight corresponding to the positive sample image may be determined, for example, as 0.5, where a sum of the first weight and the second weight is 1.

A first product of the candidate sample image and the first weight and a second product of the positive sample image and the second weight are summed to obtain a fused image. Further, after the fused image is obtained, Gaussian random noise is added to the fused image to generate the negative sample image, thereby improving the authenticity of the negative sample image and ensuring the training effect. For example, the Gaussian random noise may be introduced for a weighted summation with the fused image to obtain the negative sample image.

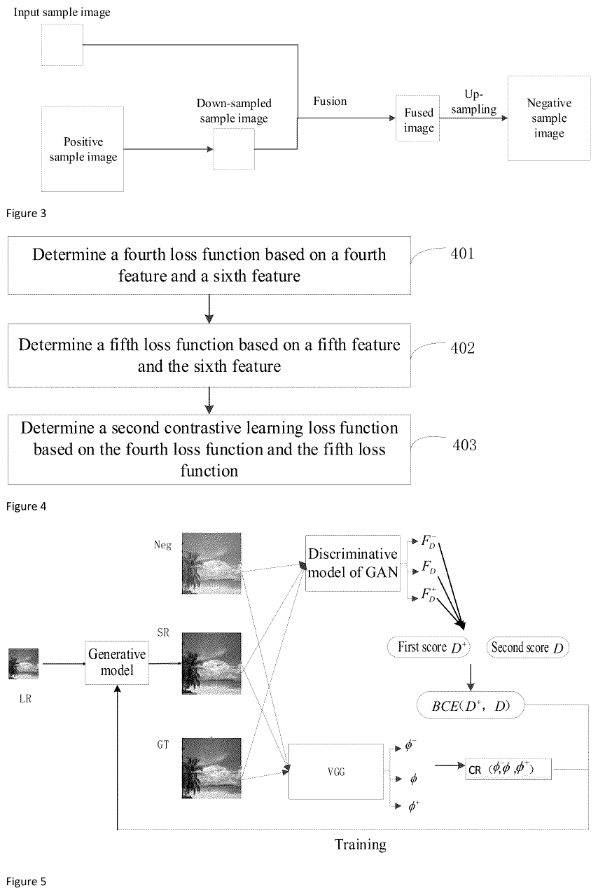

In some other embodiments of the present disclosure, with reference to FIG. 3, a down-sampled sample image is obtained by down-sampling the positive sample image based on a preset down-sampling resolution, where the down-sampled sample image has the same size as the input sample image. Further, a fused image is obtained by fusing the down-sampled sample image and the input sample image, and an image of a corresponding size obtained by up-sampling the fused image is the negative sample image, such that the negative sample image is slightly close to the positive sample image, thereby improving the training difficulty and preventing rapid convergence. Certainly, in this embodiment, after the image of the corresponding size is obtained by up-sampling the fused image, Gaussian random noise may be added to generate the negative sample image, thereby improving the authenticity of the negative sample image and ensuring the training effect.

Step 102: Extract a first feature corresponding to the positive sample image and a third feature corresponding to the reference sample image by using a discriminative model of the GAN, separately perform discrimination on the first feature and the third feature to obtain a first score corresponding to the positive sample image and a second score corresponding to the reference sample image, and determine a binary cross entropy (BCE) loss function based on the first score and the second score.

In this embodiment, in order to further improve the performance of the discriminative model of the GAN, adversarial training is performed on the first score and the second score based on the binary cross entropy (BCE) loss function, thereby ensuring that a super-resolution result becomes closer to that of the positive sample image.

In this embodiment, the discrimination is separately performed on the first feature and the third feature based on the discriminative model to obtain the first score corresponding to the positive sample image and the second score corresponding to the reference sample image.

In this embodiment, when the adversarial training is performed based on the GAN, the discrimination is separately performed on the first feature and the second feature based on the discriminative model to obtain the first score corresponding to the positive sample image and the second score corresponding to the reference sample image.

Further, the BCE loss function is determined based on the first score and the second score.

In this embodiment, the adversarial training is performed on the first score and the second score based on the binary cross entropy (BCE) loss function, thereby ensuring that the super-resolution result becomes closer to a high-frequency result of the positive sample image.

Step 103: Extract a fourth feature corresponding to the positive sample image, a fifth feature corresponding to the negative sample image, and a sixth feature corresponding to the reference sample image by using a preset network, and determine a second contrastive learning loss function based on the fourth feature, the fifth feature, and the sixth feature, where the second contrastive learning loss function is used for enabling a feature of the reference sample image to be close to a feature of the positive sample image and far away from a feature of the negative sample image.

In this embodiment, the positive sample image, the negative sample image, and the reference sample image are input into a pre-trained VGG network to obtain the fourth feature corresponding to the positive sample image, the fifth feature corresponding to the negative sample image, and the sixth feature corresponding to the reference sample image.

In this embodiment, the positive sample image, the negative sample image, and the reference sample image are input into a deep convolutional neural network, that is, the VGG network, for feature extraction to obtain the fourth feature corresponding to the positive sample image, the fifth feature corresponding to the negative sample image, and the sixth feature corresponding to the reference sample image, thereby facilitating the training of the super-resolution network in a feature dimension.

The second contrastive learning loss function is determined based on the fourth feature, the fifth feature, and the sixth feature, where the second contrastive learning loss function is used for enabling the feature of the reference sample image to be close to the feature of the positive sample image and far away from the feature of the negative sample image.

In this embodiment, in order to train the super-resolution network, the second contrastive learning loss function is determined based on the fourth feature, the fifth feature, and the sixth feature, where the second contrastive learning loss function is used for enabling the feature of the reference sample image to be close to the feature of the positive sample image and far away from the feature of the negative sample image, i.e., enabling the reference sample image to be close to the positive sample image and far away from the negative sample image at a feature level, thereby reducing the introduction of some artifacts and noise.

Thus, there is no need to introduce a large number of fake sample images for the generative adversarial learning. The super-resolution network is trained based on the calculation of loss values of the positive and negative samples in the feature dimension. In conventional generative adversarial networks (GANs), artifacts and noise are likely to be introduced into the GAN because the adversarial loss function used by the GAN only emphasizes that the output of the network is close to the ground truths (positive sample images) of the training set, without considering its distances from the negative sample images. In contrast, in this embodiment, the output of the network is not only enabled to be close to the ground truths (positive sample images), but also distanced from some defective negative samples, thereby reducing the introduced artifacts and noise.

It should be noted that a method for determining the second contrastive learning loss function based on the fourth feature, the fifth feature, and the sixth feature varies in different application scenarios, and examples are as follows.

In some embodiments of the present disclosure, as shown in FIG. 4, the determining a second contrastive learning loss function based on the fourth feature, the fifth feature, and the sixth feature includes the following steps.

Step 401: Determine a fourth loss function based on the fourth feature and the sixth feature.

In this embodiment, the fourth loss function is determined based on the sixth feature corresponding to the positive sample image and the third feature corresponding to the reference sample image, where the fourth loss function represents a distance between the reference sample image and the positive sample image.

The fourth loss function may be calculated based on any algorithm for calculating a loss value. For example, the fourth loss function may be calculated based on an L1 loss function. The L1 loss function is a mean absolute error (MAE), which is used for calculating a mean distance between the fourth feature and the sixth feature.

For another example, the fourth loss function may be calculated based on an L2 loss function. The L2 loss function is a mean squared error (MSE), which is used for calculating an average of squared differences between the fourth feature and the sixth feature.

Step 402: Determine a fifth loss function based on the fifth feature and the sixth feature.

In this embodiment, the fifth loss function is determined based on the fifth feature corresponding to the negative sample image and the sixth feature corresponding to the reference sample image, where the fifth loss function represents a distance between the reference sample image and the negative sample image.

The fifth loss function may be calculated based on any algorithm for calculating a loss value. For example, the fifth loss function may be calculated based on an L1 loss function. The L1 loss function is a mean absolute error (MAE), which is used for calculating a mean distance between the fifth feature and the sixth feature to obtain the fifth loss function.

For another example, the second loss function may be calculated based on an L2 loss function. The L2 loss function is a mean squared error (MSE), which is used for calculating an average of squared differences between the fifth feature and the sixth feature as the second loss function to obtain the fifth loss function.

Step 403: Determine the second contrastive learning loss function based on the fourth loss function and the fifth loss function.

In this embodiment, the second contrastive learning loss function is determined based on the fourth loss function and the fifth loss function, where the second contrastive learning loss function is used for enabling the feature of the reference sample image to be close to the feature of the positive sample image and far away from the feature of the negative sample image.

It should be noted that a method for determining the second contrastive learning loss function based on the fourth loss function and the fifth loss function varies in different application scenarios, and examples are as follows.

In some embodiments of the present disclosure, a ratio of the fourth loss function to the fifth loss function is calculated to obtain the second contrastive learning loss function, where the fourth loss function is an L1 loss function representing a mean absolute error between the fourth feature and the sixth feature. The fifth loss function is an L1 loss function representing a mean absolute error between the fifth feature and the sixth feature.

That is, in this embodiment, when the fourth feature is ϕ⁺, the fifth feature is ϕ⁻, and the sixth feature is ϕ, the corresponding fourth loss function is L1(ϕ,ϕ⁺), and the fifth loss function is L1(ϕ,ϕ⁻). Then, the corresponding second contrastive learning loss function is as in the following formula (1), where CR is the second contrastive learning loss function:

$$\\ \begin{matrix}CR = \frac{L 1 ( ϕ , {ϕ}^{{}_{} +} )}{L 1 ( ϕ , {ϕ}^{{}_{} -} )} & formula ( 1 )\end{matrix}$$

In some other embodiments of the present disclosure, a sum of the fourth loss function and the fifth loss function is calculated, and a ratio of the fourth loss function to the sum of the loss functions is calculated as the second contrastive learning function. Thus, the distance between the reference sample image and the positive sample image, and a loss relationship between the reference sample image and the negative sample image are determined based on the ratio.

Step 104: Train parameters of the generative model by performing backpropagation based on the BCE loss function and the second contrastive learning loss function, to obtain a target super-resolution network, so that super-resolution processing is performed on a test image based on the target super-resolution network to obtain a target super-resolution image.

In this embodiment, the parameters of the generative model are trained by performing backpropagation based on the BCE loss function and the second contrastive learning loss function, to obtain the target super-resolution network, so that the super-resolution processing is performed on the test image based on the target super-resolution network to obtain the target super-resolution image.

Therefore, in this embodiment, the reference sample image and the positive sample are close to each other at a high-frequency information level when the training of the target super-resolution network is ensured, and the closeness of the reference sample image and the positive sample at the feature level is further enhanced based on the adversarial training.

For example, as shown in FIG. 5, the sample image is a landscape image, the first feature is F_{D}⁺, the third feature is F_{D}, the first score is D⁺, the second score is D, the BCE loss function is BCE(D⁺, D), the fourth feature is ϕ⁺, the fifth feature is ϕ⁻, the sixth feature is the fourth loss function is L1(ϕ,ϕ⁺), the fifth loss function is L1(ϕ,ϕ⁻) the corresponding second contrastive learning loss function is determined to be CR(ϕ⁻,ϕ,ϕ⁺) based on the fourth loss function and the fifth loss function, the input sample image is LR, the positive sample image is GT, the negative sample image is Neg, and the reference sample image is SR. In this case, with reference to FIG. 5, the discrimination is separately performed on the first feature and the third feature based on the discriminative model to obtain the first score corresponding to the positive sample image and the second score corresponding to the reference sample image. The BCE loss function is determined based on the first score and the second score. The generative model of the GAN is trained based on the BCE loss function and the second contrastive learning loss function to obtain the target super-resolution network. The generative model of the GAN is trained based on the two loss functions so as to further ensure consistency between the super-resolution result (target super-resolution image) and the positive sample image. The generative model of the GAN is trained based on a plurality of loss functions so as to further ensure consistency between the super-resolution result (target super-resolution image) and the positive sample image at the high-frequency information level while reducing the introduction of artifacts and noise and improving details and purity of the super-resolution image.

In conclusion, the GAN-based super-resolution image processing method of this embodiment of the present disclosure includes: separately performing discrimination on the first feature and the third feature based on the discriminative model to obtain the first score corresponding to the positive sample image and the second score corresponding to the reference sample image, and determining the BCE loss function based on the first score and the second score; inputting the positive sample image, the negative sample image, and the reference sample image into a pre-trained VGG network to obtain the fourth feature corresponding to the positive sample image, the fifth feature corresponding to the negative sample image, and the sixth feature corresponding to the reference sample image, and further determining the second contrastive learning loss function based on the fourth feature, the fifth feature, and the sixth feature, where the second contrastive learning loss function is used for enabling the feature of the reference sample image to be close to the feature of the positive sample image and far away from the feature of the negative sample image; and training the generative model of the GAN based on the BCE loss function and the second contrastive learning loss function to obtain the target super-resolution network, so that the super-resolution processing is performed on the test image based on the target super-resolution network to obtain the target super-resolution image. Thus, the target super-resolution network is obtained by training based on the distance between the input sample image and the positive sample image and the distance between the input sample image and the negative sample image, and loss values at the feature level, enabling a further improvement in the purity of the target super-resolution image on the basis of ensuring the richness of image details of the target super-resolution image output by the target super-resolution network.

In practical application, in order to further enable the reference sample to be close to the positive sample and be far away from the negative sample at the feature level, thereby reducing the introduction of some artifacts and noise, the model can be further trained at the feature level based on the discriminative model of the GAN.

As shown in FIG. 6, the method further includes the following steps.

Step 601: Extract a second feature corresponding to the negative sample image by using the discriminative model of the GAN, and determine a first contrastive learning loss function based on the first feature, the second feature, and the third feature, where the first contrastive learning loss function is used for enabling the feature of the reference sample image to be close to the feature of the negative sample image and far away from the feature of the positive sample image.

In this embodiment, the positive sample image, the negative sample image, and the reference sample image are input into the discriminative model of the GAN for feature extraction to obtain the first feature corresponding to the positive sample image, the second feature corresponding to the negative sample image, and the third feature corresponding to the reference sample image.

In this embodiment, the positive sample image, the negative sample image, and the reference sample image are input into the discriminative model of the GAN for feature extraction to obtain the first feature corresponding to the positive sample image, the second feature corresponding to the negative sample image, and the third feature corresponding to the reference sample image, thereby facilitating the training of the super-resolution network in the feature dimension.

Further, the first contrastive learning loss function is determined based on the first feature, the second feature, and the third feature, where the first contrastive learning loss function is used for enabling the feature of the reference sample image to be close to the feature of the negative sample image and far away from the feature of the positive sample image.

In this embodiment, in order to train the super-resolution network, the first contrastive learning loss function is determined based on the first feature, the second feature, and the third feature, where the first contrastive learning loss function is used for enabling the feature of the reference sample image to be close to the feature of the negative sample image and far away from the feature of the positive sample image. That is, more attention is paid to noise and artifacts, such that the reference sample image is far away from the feature of the positive sample, thereby reducing the probability that the discriminative model “selectively” ignores complex noise and rare artifacts.

It should be noted that a method for determining the first contrastive learning loss function based on the first feature, the second feature, and the third feature varies in different application scenarios, and examples are as follows.

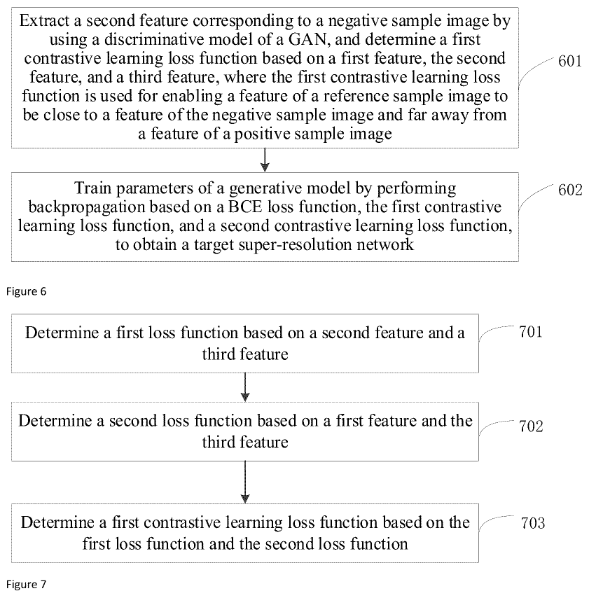

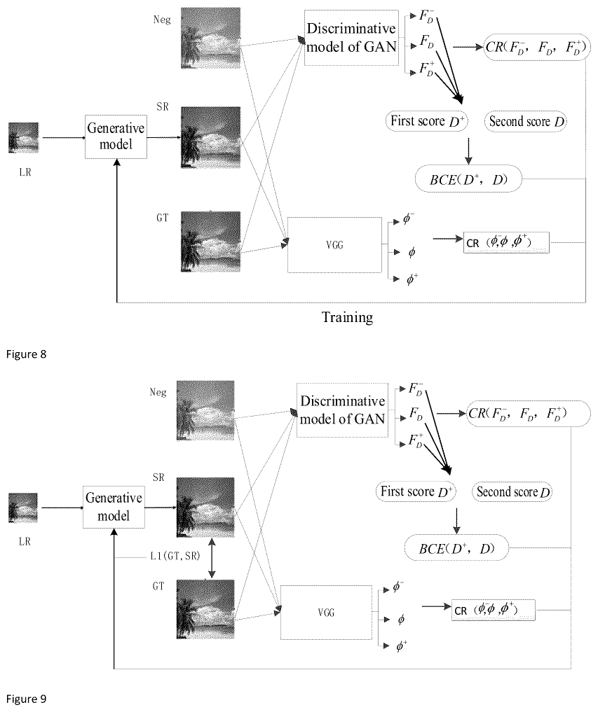

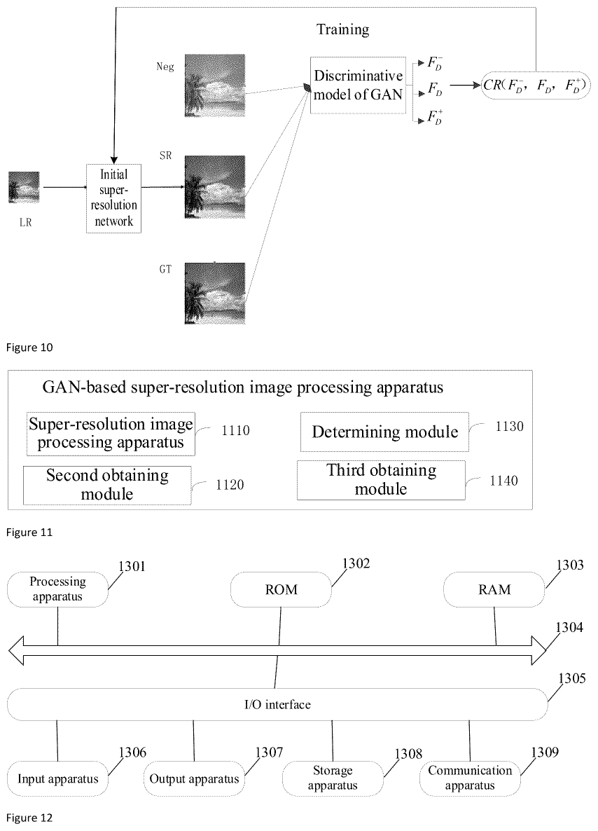

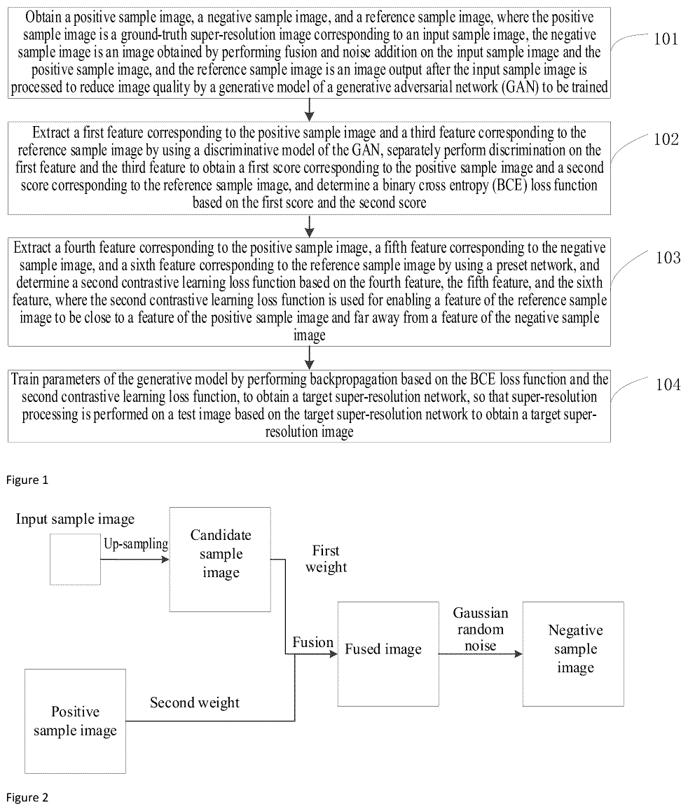

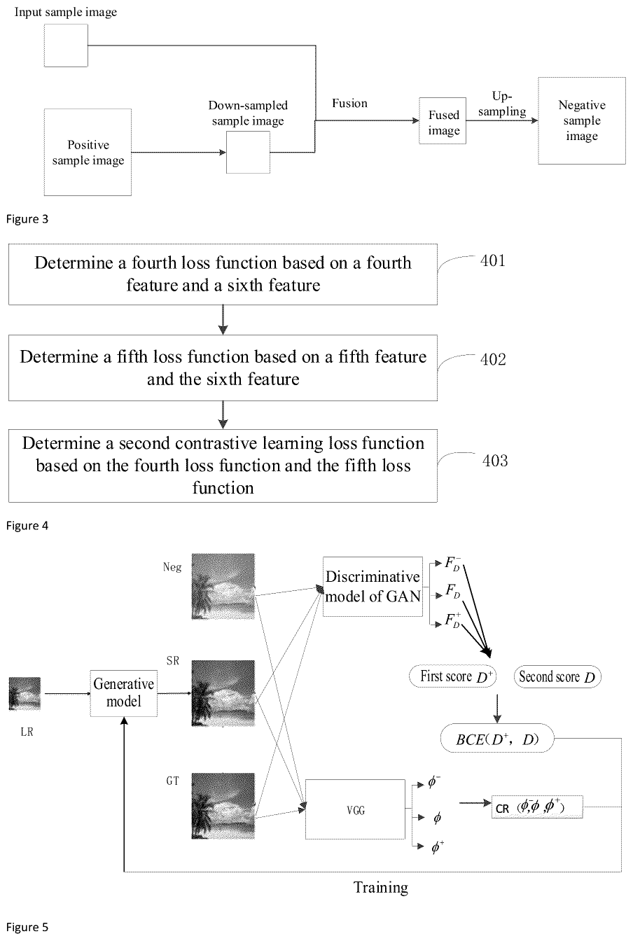

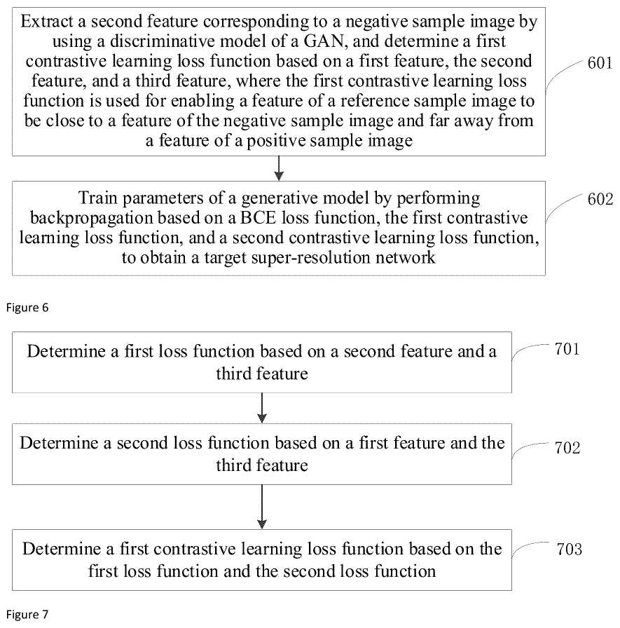

In some embodiments of the present disclosure, as shown in FIG. 7, the determining a first contrastive learning loss function based on the first feature, the second feature, and the third feature includes the following steps.

Step 701: Determine a first loss function based on the second feature and the third feature.

In this embodiment, the first loss function is determined based on the first feature corresponding to the negative sample image and the third feature corresponding to the reference sample image, where the first loss function represents a distance between the reference sample image and the negative sample image.

The first loss function may be calculated based on any algorithm for calculating a loss value. For example, the first loss function may be calculated based on an L1 loss function. The L1 loss function is a mean absolute error (MAE), which is used for calculating a mean distance between the second feature and the third feature.

For another example, the first loss function may be calculated based on an L2 loss function. The L2 loss function is a mean squared error (MSE), which is used for calculating an average of squared differences between the second feature and the third feature.

Step 702: Determine a second loss function based on the first feature and the third feature.

In this embodiment, the second loss function is determined based on the first feature corresponding to the positive sample image and the third feature corresponding to the reference sample image, where the first loss function represents a distance between the reference sample image and the positive sample image.

The second loss function may be calculated based on any algorithm for calculating a loss value. For example, the second loss function may be calculated based on an L1 loss function. The L1 loss function is a mean absolute error (MAE), which is used for calculating a mean distance between the first feature and the third feature.

For another example, the second loss function may be calculated based on an L2 loss function. The L2 loss function is a mean squared error (MSE), which is used for calculating an average of squared differences between the first feature and the third feature as the second loss function.

Step 703: Determine the first contrastive learning loss function based on the first loss function and the second loss function.

In this embodiment, the contrastive learning loss function is determined based on the first loss function and the second loss function, where the contrastive learning loss function is used for enabling the feature of the reference sample image to be far away from the feature of the positive sample image and close to the feature of the negative sample image.

It should be noted that a method for determining the contrastive learning loss function based on the first loss function and the second loss function varies in different application scenarios, and examples are as follows.

In some embodiments of the present disclosure, a ratio of the first loss function to the second loss function is calculated to obtain the first contrastive learning loss function, where the first loss function is an L1 loss function representing a mean absolute error between the second feature and the third feature. The second loss function is an L1 loss function representing a mean absolute error between the first feature and the third feature.

That is, in this embodiment, when the first feature is F_{D}⁺, the second feature is F_{D}⁻, and the third feature is F_{D}, the corresponding first loss function is L1(F_{D},F_{D}⁻) and the second loss function is L1(F_{D},F_{D}⁺). Then, the corresponding first contrastive learning loss function is as in the following formula (2), where CR is the first contrastive learning loss function:

$$\\ \begin{matrix}CR = \frac{L 1 ( {F}_{D} , {F}_{D}^{{}_{} -} )}{L 1 ( {F}_{D} , {F}_{D}^{{}_{} +} )} & formula ( 2 )\end{matrix}$$

In some other embodiments of the present disclosure, a sum of the first loss function and the second loss function is calculated, and a ratio of the first loss function to the sum of the loss functions is calculated as the contrastive learning function. Thus, the distance between the reference sample image and the positive sample image, and a loss relationship between the reference sample image and the negative sample image are determined based on the ratio.

Step 602: Train the parameters of the generative model by performing backpropagation based on the BCE loss function, the first contrastive learning loss function, and the second contrastive learning loss function, to obtain the target super-resolution network.

In this embodiment, the generative model of the GAN is trained based on the BCE loss function, the first contrastive learning loss function, and the second contrastive learning loss function to obtain the target super-resolution network.

In this embodiment, the generative model of the GAN is trained based on the BCE loss function, the first contrastive learning loss function, and the second contrastive learning loss function. That is, network parameters of the generative model of the GAN are adjusted based on loss values of the BCE loss function, the first contrastive learning loss function, and the second contrastive learning loss function, until the loss value of the BCE loss function is less than a preset loss threshold, the loss value of the first contrastive learning loss function is less than a corresponding loss threshold, and the loss value of the second contrastive learning loss function is also less than a corresponding loss threshold, so as to obtain the trained target super-resolution network.

Therefore, in this embodiment, the reference sample image and the positive sample are close to each other at a high-frequency information level when the training of the target super-resolution network is ensured, and the closeness of the reference sample image and the positive sample at the feature level is further enhanced based on the adversarial training.

For example, as shown in FIG. 8, the sample image is a landscape image, the first feature is F_{D}⁺, the third feature is F_{D}, the first score is D⁺, the second score is D, the BCE loss function is BCE(D⁺, D) the first contrastive learning loss function is CR(F_{D}⁻, F_{D}, F_{D}⁺), the second contrastive learning loss function is CR(ϕ⁻,ϕ,ϕ⁺), the input sample image is LR, the positive sample image is GT, and the reference sample image is SR. In this case, with reference to FIG. 8, the discrimination is separately performed on the first feature and the third feature based on the discriminative model to obtain the first score corresponding to the positive sample image and the second score corresponding to the reference sample image. The BCE loss function is determined based on the first score and the second score. The generative model of the GAN is trained based on the BCE loss function, the first contrastive learning loss function, and the second contrastive learning loss function to obtain the target super-resolution network. The generative model of the GAN is trained based on the two loss functions so as to further ensure consistency between the super-resolution result (target super-resolution image) and the positive sample image, and supervised training is performed on a feature extraction process of the GAN based on the first contrastive learning loss function, which improves the sensitivity of the discriminative model to noise and artifacts.

In this embodiment of the present disclosure, when the generative model of the GAN is trained, a third loss function may be further determined based on the reference sample image and the positive sample image. For example, an L1 loss function representing a mean absolute error is determined based on the reference sample image and the positive sample image to determine the third loss function. For another example, an L2 loss function representing an average of squared differences is determined based on the reference sample image and the positive sample image to determine the third loss function. Further, the generative model of the GAN is trained based on the BCE loss function, the third loss function, the first contrastive learning loss function, and the second contrastive learning loss function. That is, network parameters of the generative model of the GAN are adjusted based on the BCE loss function, the third loss function, the first contrastive learning loss function, and the second contrastive learning loss function, until the loss value of the third loss function is less than a preset loss threshold, the loss value of the BCE loss function is less than a preset loss threshold, the loss value of the first contrastive learning loss function is less than a corresponding loss threshold, and the loss value of the second contrastive learning loss function is less than a corresponding loss threshold, so as to obtain the trained target super-resolution network.

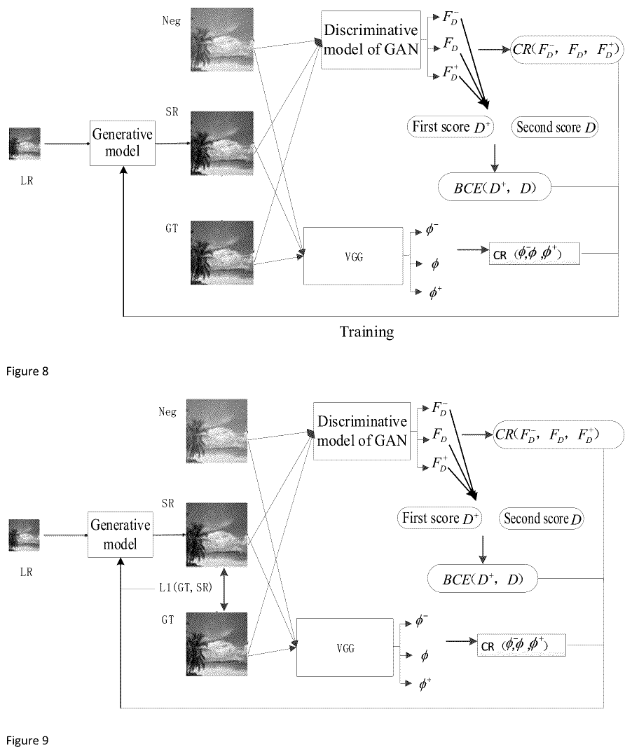

For example, as shown in FIG. 9, with the scenario shown in FIG. 8 as an example, the third loss function L1(GT, SR) is further determined based on the reference sample image and the positive sample image. The generative model of the GAN is trained jointly based on the third loss function, the first contrastive learning function, the BCE loss function, and the second contrastive learning function. The generative model of the GAN is trained based on a plurality of loss functions so as to further ensure consistency between the super-resolution result (target super-resolution image) and the positive sample image at the high-frequency information level while reducing the introduction of artifacts and noise and improving details and purity of the super-resolution image.

Therefore, in this embodiment, the reference sample image is close to the positive sample and far away from the negative sample image at the feature level when the training of the target super-resolution network is ensured, thereby reducing the introduction of some artifacts and noise. Further, the target super-resolution network is trained based on the third loss function obtained based on the reference sample image and the positive sample image, such that the closeness of the reference sample image and the positive sample at the feature level is enhanced. In addition, the feature extraction process of the discriminative model is supervised based on the first contrastive learning loss function such that the discriminative model is more sensitive to noise and artifacts, thereby improving the purity of the target super-resolution image generated based on the target super-resolution network.

Certainly, in some embodiments of the present disclosure, the target super-resolution network may be trained based on only the first contrastive learning function.

In this embodiment, the generative model of the GAN is trained based on the first contrastive learning loss function. For example, a preset threshold corresponding to the first contrastive learning loss function is preset, and when the loss value of the first contrastive learning loss function is greater than the preset threshold, the network parameters of the generative model of the GAN are modified, until the loss value of the first contrastive learning loss function is not greater than the preset threshold, so as to obtain the corresponding target super-resolution network. Therefore, the CR loss for the feature extraction part of the discriminative model is added in the training process of the target super-resolution network, such that the trained target super-resolution model can be significantly improved in the super-resolution effect on an image of a low quality, with significant improvements in noise suppression and detail generation. Thus, the target super-resolution image is obtained by super-resolution processing on the test image based on the target super-resolution network, thereby obtaining a high purity on the basis of improving the richness of image details.

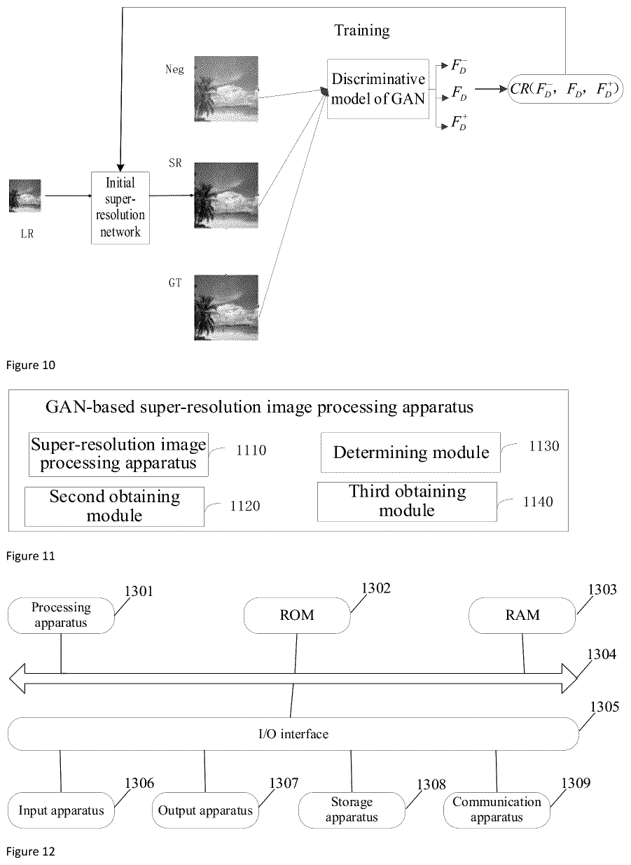

For example, as shown in FIG. 10, the sample image is a landscape image, the first feature is F_{D}⁺, the second feature is F_{D}⁻, the third feature is F_{D}, the first contrastive learning loss function is CR(F_{D}⁻, F_{D}, F_{D}⁻), the input sample image is LR, the positive sample image is GT, the negative sample image is Neg, and the reference sample image is SR. In this case, with reference to FIG. 10, the first contrastive learning loss function is determined based on the first feature, the second feature, and the third feature, where the first contrastive learning loss function is used for enabling a feature of the reference sample image to be close to a feature of the negative sample image and far away from a feature of the positive sample image.

Thus, the positive sample image, the negative sample image, and the reference sample image are input into the feature extraction part of the GAN to calculate the CR losses of the three images simultaneously, such that in feature extraction, the GAN tends to enable the feature of the SR reference sample image to be close to the feature of the negative sample image, i.e., more attention is paid by the GAN to noise and artifacts, and such that the feature of the reference sample image is enabled to be far away from the feature of the positive sample image, thereby reducing the probability that the GAN “selectively” ignores complex noise and rare artifacts. Due to the existence of the CR loss for the feature part of the GAN, the subsequent GAN discriminative module can distinguish features of the super-resolution image from features of the real high-definition image more easily, thereby reducing the training difficulty of the GAN in complex data sets.

In conclusion, in the GAN-based super-resolution image processing method of this embodiment of the present disclosure, on the basis of supervising the feature extraction process of the discriminative model based on the first contrastive learning loss function such that the discriminative model is more sensitive to noise and artifacts, the reference sample image is close to the positive sample and far away from the negative sample image at the feature level when the training of the target super-resolution network is ensured, thereby reducing the introduction of some artifacts and noise. Further, the target super-resolution network is trained based on the third loss function obtained based on the reference sample image and the positive sample image, such that the closeness of the reference sample image and the positive sample at the feature level is enhanced.

In order to implement the above embodiments, the present disclosure further provides a GAN-based super-resolution image processing apparatus. FIG. 11 is a schematic diagram of a structure of a GAN-based super-resolution image processing apparatus according to an embodiment of the present disclosure. The apparatus may be implemented using software and/or hardware and may generally be integrated into an electronic device. As shown in FIG. 11, the apparatus includes: a first obtaining module 1110, a second obtaining module 1120, a determining module 1130, and a third obtaining module 1140.

The first obtaining module 1110 is configured to obtain a positive sample image, a negative sample image, and a reference sample image, where the positive sample image is a ground-truth super-resolution image corresponding to an input sample image, the negative sample image is an image obtained by performing fusion and noise addition on the input sample image and the positive sample image, and the reference sample image is an image output after the input sample image is processed to reduce image quality by a generative model of a generative adversarial network (GAN) to be trained.

The second obtaining module 1120 is configured to extract a first feature corresponding to the positive sample image and a third feature corresponding to the reference sample image by using a discriminative model of the GAN, separately perform discrimination on the first feature and the third feature to obtain a first score corresponding to the positive sample image and a second score corresponding to the reference sample image, and determine a binary cross entropy (BCE) loss function based on the first score and the second score.

The determining module 1130 is configured to extract a fourth feature corresponding to the positive sample image, a fifth feature corresponding to the negative sample image, and a sixth feature corresponding to the reference sample image by using a preset network, and determine a second contrastive learning loss function based on the fourth feature, the fifth feature, and the sixth feature, where the second contrastive learning loss function is used for enabling a feature of the reference sample image to be close to a feature of the positive sample image and far away from a feature of the negative sample image.

The third obtaining module 1140 is configured to train parameters of the generative model by performing backpropagation based on the BCE loss function and the second contrastive learning loss function, to obtain a target super-resolution network, so that super-resolution processing is performed on a test image based on the target super-resolution network to obtain a target super-resolution image.

The GAN-based super-resolution image processing apparatus provided in this embodiment of the present disclosure can perform the GAN-based super-resolution image processing method provided in any one of the embodiments of the present disclosure, and has corresponding functional modules and beneficial effects for performing the method.

In order to implement the above embodiments, the present disclosure further provides a computer program product including a computer program/instruction that, when executed by a processor, implements the GAN-based super-resolution image processing method in the above embodiments.

FIG. 12 is a schematic diagram of a structure of an electronic device according to an embodiment of the present disclosure.

Reference is made specifically to FIG. 12 below, which is a schematic diagram of a structure of an electronic device 1300 suitable for implementing the embodiments of the present disclosure. The electronic device 1300 in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 12 is merely an example, and shall not impose any limitation on the function and scope of use of the embodiments of the present disclosure.

As shown in FIG. 12, the electronic device 1300 may include a processing apparatus (e.g., a central processing unit, a graphics processing unit, etc.) 1301 that may perform a variety of appropriate actions and processing in accordance with a program stored in a read-only memory (ROM) 1302 or a program loaded from a storage apparatus 1308 into a random access memory (RAM) 1303. The RAM 1303 further stores various programs and data required for the operation of the electronic device 1300. The processing apparatus 1301, the ROM 1302, and the RAM 1303 are connected to each other through a bus 1304. An input/output (I/O) interface 1305 is also connected to the bus 1304.

Generally, the following apparatuses may be connected to the I/O interface 1305: an input apparatus 1306 including, for example, a touch screen, a touchpad, a keyboard, a mouse, a camera, a microphone, an accelerometer, and a gyroscope; an output apparatus 1307 including, for example, a liquid crystal display (LCD), a speaker, and a vibrator; the storage apparatus 1308 including, for example, a tape and a hard disk; and a communication apparatus 1309. The communication apparatus 1309 may allow the electronic device 1300 to perform wireless or wired communication with other devices to exchange data. Although FIG. 12 shows the electronic device 1300 having various apparatuses, it should be understood that it is not required to implement or have all of the shown apparatuses. It may be an alternative to implement or have more or fewer apparatuses.

In particular, according to an embodiment of the present disclosure, the processes described above with reference to the flowcharts may be implemented as a computer software program. For example, this embodiment of the present disclosure includes a computer program product, which includes a computer program carried on a non-transitory computer-readable medium, where the computer program includes program code for performing the methods shown in the flowcharts. In such an embodiment, the computer program may be downloaded from a network through the communication apparatus 1309 and installed, installed from the storage apparatus 1308, or installed from the ROM 1302. When the computer program is executed by the processing apparatus 1301, the above functions defined in the GAN-based super-resolution image processing method in the embodiments of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as a HyperText Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: obtain a positive sample image, a negative sample image, and a reference sample image, where the positive sample image is a ground-truth super-resolution image corresponding to an input sample image, the negative sample image is an image obtained by performing fusion and noise addition on the input sample image and the positive sample image, and the reference sample image is an image output after the input sample image is processed to reduce image quality by using a generative model of a generative adversarial network (GAN) to be trained; extract a first feature corresponding to the positive sample image and a third feature corresponding to the reference sample image by using a discriminative model of the GAN, separately perform discrimination on the first feature and the third feature to obtain a first score corresponding to the positive sample image and a second score corresponding to the reference sample image, and determine a binary cross entropy (BCE) loss function based on the first score and the second score; extract a fourth feature corresponding to the positive sample image, a fifth feature corresponding to the negative sample image, and a sixth feature corresponding to the reference sample image by using a preset network, and determine a second contrastive learning loss function based on the fourth feature, the fifth feature, and the sixth feature, where the second contrastive learning loss function is used for enabling a feature of the reference sample image to be close to a feature of the positive sample image and far away from a feature of the negative sample image; and train parameters of the generative model by performing backpropagation based on the BCE loss function and the second contrastive learning loss function, to obtain a target super-resolution network, so that super-resolution processing is performed on a test image based on the target super-resolution network to obtain a target super-resolution image.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagrams in the accompanying drawings illustrate the possibly implemented architecture, functions, and operations of the system, method, and computer program product according to various embodiments of the present disclosure. In this regard, each block in the flowcharts or the block diagrams may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagrams and/or the flowcharts, and a combination of the blocks in the block diagrams and/or the flowcharts may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, the present disclosure provides a GAN-based super-resolution image processing method. The method includes:
obtaining a positive sample image, a negative sample image, and a reference sample image, where the positive sample image is a ground-truth super-resolution image corresponding to an input sample image, the negative sample image is an image obtained by performing fusion and noise addition on the input sample image and the positive sample image, and the reference sample image is an image output after the input sample image is processed to reduce image quality by a generative model of a generative adversarial network (GAN) to be trained;
extracting a first feature corresponding to the positive sample image and a third feature corresponding to the reference sample image by using a discriminative model of the GAN, separately performing discrimination on the first feature and the third feature to obtain a first score corresponding to the positive sample image and a second score corresponding to the reference sample image, and determining a binary cross entropy (BCE) loss function based on the first score and the second score;
extracting a fourth feature corresponding to the positive sample image, a fifth feature corresponding to the negative sample image, and a sixth feature corresponding to the reference sample image by using a preset network, and determining a second contrastive learning loss function based on the fourth feature, the fifth feature, and the sixth feature, where the second contrastive learning loss function is used for enabling a feature of the reference sample image to be close to a feature of the positive sample image and far away from a feature of the negative sample image; and
training parameters of the generative model by performing backpropagation based on the BCE loss function and the second contrastive learning loss function, to obtain a target super-resolution network, so that super-resolution processing is performed on a test image based on the target super-resolution network to obtain a target super-resolution image.

According to one or more embodiments of the present disclosure, in the GAN-based super-resolution image processing method provided in the present disclosure, a process of generating the negative sample image includes:
up-sampling the input sample image to obtain a candidate sample image with the same size as the positive sample image;
determining a first weight corresponding to the candidate sample image, and determining a second weight corresponding to the positive sample image;
summing a first product of the candidate sample image and the first weight and a second product of the positive sample image and the second weight to obtain a fused image; and
adding Gaussian random noise to the fused image to generate the negative sample image.

According to one or more embodiments of the present disclosure, in the GAN-based super-resolution image processing method provided in the present disclosure, the determining a second contrastive learning loss function based on the fourth feature, the fifth feature, and the sixth feature includes:
determining a fourth loss function based on the fourth feature and the sixth feature;
determining a fifth loss function based on the fifth feature and the sixth feature; and
determining the second contrastive learning loss function based on the fourth loss function and the fifth loss function.

According to one or more embodiments of the present disclosure, in the GAN-based super-resolution image processing method provided in the present disclosure, the determining the second contrastive learning loss function based on the fourth loss function and the fifth loss function includes:
calculating a ratio of the fourth loss function to the fifth loss function to obtain the second contrastive learning loss function, where the fourth loss function is an L1 loss function representing a mean absolute error between the fourth feature and the sixth feature, and the fifth loss function is an L1 loss function representing a mean absolute error between the fifth feature and the sixth feature.

According to one or more embodiments of the present disclosure, in the GAN-based super-resolution image processing method provided in the present disclosure, the method further includes:
extracting a second feature corresponding to the negative sample image by using the discriminative model of the GAN, and determining a first contrastive learning loss function based on the first feature, the second feature, and the third feature, where the first contrastive learning loss function is used for enabling the feature of the reference sample image to be close to the feature of the negative sample image and far away from the feature of the positive sample image; and
the training parameters of the generative model by performing backpropagation based on the BCE loss function and the second contrastive learning loss function, to obtain a target super-resolution network includes:
training the parameters of the generative model by performing backpropagation based on the BCE loss function, the first contrastive learning loss function, and the second contrastive learning loss function, to obtain the target super-resolution network.

According to one or more embodiments of the present disclosure, in the GAN-based super-resolution image processing method provided in the present disclosure, the determining a first contrastive learning loss function based on the first feature, the second feature, and the third feature includes:
determining a first loss function based on the second feature and the third feature;
determining a second loss function based on the first feature and the third feature; and
determining the first contrastive learning loss function based on the first loss function and the second loss function.

According to one or more embodiments of the present disclosure, in the GAN-based super-resolution image processing method provided in the present disclosure, the determining the first contrastive learning loss function based on the first loss function and the second loss function includes:
calculating a ratio of the first loss function to the second loss function to obtain the first contrastive learning loss function, where the first loss function is an L1 loss function representing a mean absolute error between the second feature and the third feature, and the second loss function is an L1 loss function representing a mean absolute error between the first feature and the third feature.

According to one or more embodiments of the present disclosure, in the GAN-based super-resolution image processing method provided in the present disclosure,
the method further includes:
determining a third loss function based on the reference sample image and the positive sample image; and
the training the parameters of the generative model by performing backpropagation based on the BCE loss function, the first contrastive learning loss function, and the second contrastive learning loss function, to obtain the target super-resolution network includes:
training the parameters of the generative model by performing backpropagation based on the BCE loss function, the third loss function, the second contrastive learning loss function, and the first contrastive learning loss function, to obtain the target super-resolution network. According to one or more embodiments of the present disclosure, the present disclosure provides a GAN-based super-resolution image processing apparatus. The apparatus includes:
a first obtaining module configured to obtain a positive sample image, a negative sample image, and a reference sample image, where the positive sample image is a ground-truth super-resolution image corresponding to an input sample image, the negative sample image is an image obtained by performing fusion and noise addition on the input sample image and the positive sample image, and the reference sample image is an image output after the input sample image is processed to reduce image quality by a generative model of a generative adversarial network (GAN) to be trained;
a second obtaining module configured to extract a first feature corresponding to the positive sample image and a third feature corresponding to the reference sample image by using a discriminative model of the GAN, separately perform discrimination on the first feature and the third feature to obtain a first score corresponding to the positive sample image and a second score corresponding to the reference sample image, and determine a binary cross entropy (BCE) loss function based on the first score and the second score;
a determining module configured to extract a fourth feature corresponding to the positive sample image, a fifth feature corresponding to the negative sample image, and a sixth feature corresponding to the reference sample image by using a preset network, and determine a second contrastive learning loss function based on the fourth feature, the fifth feature, and the sixth feature, where the second contrastive learning loss function is used for enabling a feature of the reference sample image to be close to a feature of the positive sample image and far away from a feature of the negative sample image; and
a third obtaining module configured to train parameters of the generative model by performing backpropagation based on the BCE loss function and the second contrastive learning loss function, to obtain a target super-resolution network, so that super-resolution processing is performed on a test image based on the target super-resolution network to obtain a target super-resolution image.

According to one or more embodiments of the present disclosure, in the GAN-based super-resolution image processing apparatus provided in the present disclosure, the first obtaining module is specifically configured to:
up-sample the input sample image to obtain a candidate sample image with the same size as the positive sample image;
determine a first weight corresponding to the candidate sample image, and determine a second weight corresponding to the positive sample image;
sum a first product of the candidate sample image and the first weight and a second product of the positive sample image and the second weight to obtain a fused image; and
add Gaussian random noise to the fused image to generate the negative sample image.

According to one or more embodiments of the present disclosure, in the GAN-based super-resolution image processing apparatus provided in the present disclosure, the determining module is specifically configured to:
determine a first loss function based on the second feature and the third feature;
determine a second loss function based on the first feature and the third feature; and
determine the first contrastive learning loss function based on the first loss function and the second loss function.

According to one or more embodiments of the present disclosure, in the GAN-based super-resolution image processing apparatus provided in the present disclosure, the apparatus further includes:
a first loss function determining module configured to determine a fourth loss function based on the fourth feature and the sixth feature;
a second loss function determining module configured to determine a fifth loss function based on the fifth feature and the sixth feature; and
a third loss function determining module configured to determine the second contrastive learning loss function based on the fourth loss function and the fifth loss function.

According to one or more embodiments of the present disclosure, in the GAN-based super-resolution image processing apparatus provided in the present disclosure, the third loss function determining module is specifically configured to:
calculate a ratio of the fourth loss function to the fifth loss function to obtain the second contrastive learning loss function, where the fourth loss function is an L1 loss function representing a mean absolute error between the fourth feature and the sixth feature, and the fifth loss function is an L1 loss function representing a mean absolute error between the fifth feature and the sixth feature.

According to one or more embodiments of the present disclosure, in the GAN-based super-resolution image processing apparatus provided in the present disclosure, the apparatus further includes:
an extraction module configured to extract a second feature corresponding to the negative sample image by using the discriminative model of the GAN, and determine a first contrastive learning loss function based on the first feature, the second feature, and the third feature, where the first contrastive learning loss function is used for enabling the feature of the reference sample image to be close to the feature of the negative sample image and far away from the feature of the positive sample image;
the third obtaining module is specifically configured to:
train the parameters of the generative model by performing backpropagation based on the BCE loss function, the first contrastive learning loss function, and the second contrastive learning loss function, to obtain the target super-resolution network.

According to one or more embodiments of the present disclosure, in the GAN-based super-resolution image processing apparatus provided in the present disclosure, the extraction module is specifically configured to:
determine a first loss function based on the second feature and the third feature;
determine a second loss function based on the first feature and the third feature; and
determine the first contrastive learning loss function based on the first loss function and the second loss function.

According to one or more embodiments of the present disclosure, in the GAN-based super-resolution image processing apparatus provided in the present disclosure, the extraction module is specifically configured to:
calculate a ratio of the first loss function to the second loss function to obtain the first contrastive learning loss function, where the first loss function is an L1 loss function representing a mean absolute error between the second feature and the third feature, and the second loss function is an L1 loss function representing a mean absolute error between the first feature and the third feature.

According to one or more embodiments of the present disclosure, in the GAN-based super-resolution image processing apparatus provided in the present disclosure, the apparatus further includes:
a fourth loss function determining module configured to determine a third loss function based on the reference sample image and the positive sample image;
the third obtaining module is specifically configured to train the parameters of the generative model by performing backpropagation based on the BCE loss function, the third loss function, the second contrastive learning loss function, and the first contrastive learning loss function, to obtain the target super-resolution network.

According to one or more embodiments of the present disclosure, the present disclosure provides an electronic device. The electronic device includes:
a processor; and
a memory configured to store instructions executable by the processor, where
the processor is configured to read the executable instructions from the memory, and execute the instructions to implement the GAN-based super-resolution image processing method as described in any of the embodiments of the present disclosure.

According to one or more embodiments of the present disclosure, the present disclosure provides a computer-readable storage medium having stored thereon a computer program for performing the GAN-based super-resolution image processing method as described in any of the embodiments of the present disclosure.

The above descriptions are merely preferred embodiments of the present disclosure and explanations of the applied technical principles. Those skilled in the art should understand that the scope of disclosure involved in the present disclosure is not limited to the technical solutions formed by specific combinations of the above technical features, and shall also cover other technical solutions formed by any combination of the above technical features or equivalent features thereof without departing from the above concept of disclosure. For example, a technical solution formed by a replacement of the above features with technical features with similar functions disclosed in the present disclosure (but not limited thereto) also falls within the scope of the present disclosure.

In addition, although the various operations are depicted in a specific order, it should not be understood as requiring these operations to be performed in the specific order shown or in a sequential order. Under specific circumstances, multitasking and parallel processing may be advantageous. Similarly, although several specific implementation details are included in the above discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A GAN-based super-resolution image processing method, comprising:
obtaining a positive sample image, a negative sample image, and a reference sample image, wherein the positive sample image is a ground-truth super-resolution image corresponding to an input sample image, the negative sample image is an image obtained by performing fusion and noise addition on the input sample image and the positive sample image, and the reference sample image is an image output after the input sample image is processed to reduce image quality by a generative model of a generative adversarial network (GAN) to be trained;
extracting a first feature corresponding to the positive sample image and a third feature corresponding to the reference sample image by using a discriminative model of the GAN, separately performing discrimination on the first feature and the third feature to obtain a first score corresponding to the positive sample image and a second score corresponding to the reference sample image, and determining a binary cross entropy (BCE) loss function based on the first score and the second score;
extracting a fourth feature corresponding to the positive sample image, a fifth feature corresponding to the negative sample image, and a sixth feature corresponding to the reference sample image by using a preset network, and determining a second contrastive learning loss function based on the fourth feature, the fifth feature, and the sixth feature, wherein the second contrastive learning loss function is used for enabling a feature of the reference sample image to be close to a feature of the positive sample image and far away from a feature of the negative sample image; and
training parameters of the generative model by performing backpropagation based on the BCE loss function and the second contrastive learning loss function, to obtain a target super-resolution network, so that super-resolution processing is performed on a test image based on the target super-resolution network to obtain a target super-resolution image.

2. The method according to claim 1, wherein a process of generating the negative sample image comprises:
up-sampling the input sample image to obtain a candidate sample image with the same size as the positive sample image;
determining a first weight corresponding to the candidate sample image, and determining a second weight corresponding to the positive sample image;
summing a first product of the candidate sample image and the first weight and a second product of the positive sample image and the second weight to obtain a fused image; and
adding Gaussian random noise to the fused image to generate the negative sample image.

3. The method according to claim 1, wherein the determining a second contrastive learning loss function based on the fourth feature, the fifth feature, and the sixth feature comprises:
determining a fourth loss function based on the fourth feature and the sixth feature;
determining a fifth loss function based on the fifth feature and the sixth feature; and
determining the second contrastive learning loss function based on the fourth loss function and the fifth loss function.

4. The method according to claim 3, wherein the determining the second contrastive learning loss function based on the fourth loss function and the fifth loss function comprises:
calculating a ratio of the fourth loss function to the fifth loss function to obtain the second contrastive learning loss function, wherein the fourth loss function is an L1 loss function representing a mean absolute error between the fourth feature and the sixth feature, and the fifth loss function is an L1 loss function representing a mean absolute error between the fifth feature and the sixth feature.

5. The method according to claim 1, wherein the method further comprises:
extracting a second feature corresponding to the negative sample image by using the discriminative model of the GAN, and determining a first contrastive learning loss function based on the first feature, the second feature, and the third feature, wherein the first contrastive learning loss function is used for enabling the feature of the reference sample image to be close to the feature of the negative sample image and far away from the feature of the positive sample image; and
the training parameters of the generative model by performing backpropagation based on the BCE loss function and the second contrastive learning loss function, to obtain a target super-resolution network comprises:
training the parameters of the generative model by performing backpropagation based on the BCE loss function, the first contrastive learning loss function, and the second contrastive learning loss function, to obtain the target super-resolution network.

6. The method according to claim 5, wherein the determining a first contrastive learning loss function based on the first feature, the second feature, and the third feature comprises:
determining a first loss function based on the second feature and the third feature;
determining a second loss function based on the first feature and the third feature; and
determining the first contrastive learning loss function based on the first loss function and the second loss function.

7. The method according to claim 6, wherein the determining the first contrastive learning loss function based on the first loss function and the second loss function comprises:
calculating a ratio of the first loss function to the second loss function to obtain the first contrastive learning loss function, wherein the first loss function is an L1 loss function representing a mean absolute error between the second feature and the third feature, and the second loss function is an L1 loss function representing a mean absolute error between the first feature and the third feature.

8. The method according to claim 5, wherein the method further comprises:
determining a third loss function based on the reference sample image and the positive sample image; and
the training the parameters of the generative model by performing backpropagation based on the BCE loss function, the first contrastive learning loss function, and the second contrastive learning loss function, to obtain the target super-resolution network comprises:
training the parameters of the generative model by performing backpropagation based on the BCE loss function, the third loss function, the second contrastive learning loss function, and the first contrastive learning loss function, to obtain the target super-resolution network.

9. (canceled)

10. An electronic device, comprising:
a processor; and
a memory configured to store instructions executable by the processor, wherein the processor is configured to read the executable instructions from the memory, and execute the instructions to implement a GAN-based super-resolution image processing method, the GAN-based super-resolution image processing method comprises:
obtaining a positive sample image, a negative sample image, and a reference sample image, wherein the positive sample image is a ground-truth super-resolution image corresponding to an input sample image, the negative sample image is an image obtained by performing fusion and noise addition on the input sample image and the positive sample image, and the reference sample image is an image output after the input sample image is processed to reduce image quality by a generative model of a generative adversarial network (GAN) to be trained;
extracting a first feature corresponding to the positive sample image and a third feature corresponding to the reference sample image by using a discriminative model of the GAN, separately performing discrimination on the first feature and the third feature to obtain a first score corresponding to the positive sample image and a second score corresponding to the reference sample image, and determining a binary cross entropy (BCE) loss function based on the first score and the second score;
extracting a fourth feature corresponding to the positive sample image, a fifth feature corresponding to the negative sample image, and a sixth feature corresponding to the reference sample image by using a preset network, and determining a second contrastive learning loss function based on the fourth feature, the fifth feature, and the sixth feature, wherein the second contrastive learning loss function is used for enabling a feature of the reference sample image to be close to a feature of the positive sample image and far away from a feature of the negative sample image; and
training parameters of the generative model by performing backpropagation based on the BCE loss function and the second contrastive learning loss function, to obtain a target super-resolution network, so that super-resolution processing is performed on a test image based on the target super-resolution network to obtain a target super-resolution image.

11. A non-transitory computer-readable storage medium having stored thereon a computer program for performing a GAN-based super-resolution image processing method, the GAN-based super-resolution image processing method comprising:
obtaining a positive sample image, a negative sample image, and a reference sample image, wherein the positive sample image is a ground-truth super-resolution image corresponding to an input sample image, the negative sample image is an image obtained by performing fusion and noise addition on the input sample image and the positive sample image, and the reference sample image is an image output after the input sample image is processed to reduce image quality by a generative model of a generative adversarial network (GAN) to be trained;
extracting a first feature corresponding to the positive sample image and a third feature corresponding to the reference sample image by using a discriminative model of the GAN, separately performing discrimination on the first feature and the third feature to obtain a first score corresponding to the positive sample image and a second score corresponding to the reference sample image, and determining a binary cross entropy (BCE) loss function based on the first score and the second score;
extracting a fourth feature corresponding to the positive sample image, a fifth feature corresponding to the negative sample image, and a sixth feature corresponding to the reference sample image by using a preset network, and determining a second contrastive learning loss function based on the fourth feature, the fifth feature, and the sixth feature, wherein the second contrastive learning loss function is used for enabling a feature of the reference sample image to be close to a feature of the positive sample image and far away from a feature of the negative sample image; and
training parameters of the generative model by performing backpropagation based on the BCE loss function and the second contrastive learning loss function, to obtain a target super-resolution network, so that super-resolution processing is performed on a test image based on the target super-resolution network to obtain a target super-resolution image.

12. The electronic device according to claim 10, wherein a process of generating the negative sample image comprises:
up sampling the input sample image to obtain a candidate sample image with the same size as the positive sample image;
determining a first weight corresponding to the candidate sample image, and determining a second weight corresponding to the positive sample image;
summing a first product of the candidate sample image and the first weight and a second product of the positive sample image and the second weight to obtain a fused image; and
adding Gaussian random noise to the fused image to generate the negative sample image.

13. The electronic device according to claim 10, wherein the determining a second contrastive learning loss function based on the fourth feature, the fifth feature, and the sixth feature comprises:
determining a fourth loss function based on the fourth feature and the sixth feature;
determining a fifth loss function based on the fifth feature and the sixth feature; and
determining the second contrastive learning loss function based on the fourth loss function and the fifth loss function.

14. The electronic device according to claim 13, wherein the determining the second contrastive learning loss function based on the fourth loss function and the fifth loss function comprises:
calculating a ratio of the fourth loss function to the fifth loss function to obtain the second contrastive learning loss function, wherein the fourth loss function is an L1 loss function representing a mean absolute error between the fourth feature and the sixth feature, and the fifth loss function is an L1 loss function representing a mean absolute error between the fifth feature and the sixth feature.

15. The electronic device according to claim 10, wherein the method further comprises:
extracting a second feature corresponding to the negative sample image by using the discriminative model of the GAN, and determining a first contrastive learning loss function based on the first feature, the second feature, and the third feature, wherein the first contrastive learning loss function is used for enabling the feature of the reference sample image to be close to the feature of the negative sample image and far away from the feature of the positive sample image; and
the training parameters of the generative model by performing backpropagation based on the BCE loss function and the second contrastive learning loss function, to obtain a target super-resolution network comprises:
training the parameters of the generative model by performing backpropagation based on the BCE loss function, the first contrastive learning loss function, and the second contrastive learning loss function, to obtain the target super-resolution network.

16. The electronic device according to claim 15, wherein the determining a first contrastive learning loss function based on the first feature, the second feature, and the third feature comprises:
determining a first loss function based on the second feature and the third feature;
determining a second loss function based on the first feature and the third feature; and
determining the first contrastive learning loss function based on the first loss function and the second loss function.

17. The electronic device according to claim 16, wherein the determining the first contrastive learning loss function based on the first loss function and the second loss function comprises:
calculating a ratio of the first loss function to the second loss function to obtain the first contrastive learning loss function, wherein the first loss function is an L1 loss function representing a mean absolute error between the second feature and the third feature, and the second loss function is an L1 loss function representing a mean absolute error between the first feature and the third feature.

18. The electronic device according to claim 15, wherein the method further comprises:
determining a third loss function based on the reference sample image and the positive sample image; and
the training the parameters of the generative model by performing backpropagation based on the BCE loss function, the first contrastive learning loss function, and the second contrastive learning loss function, to obtain the target super-resolution network comprises:
training the parameters of the generative model by performing backpropagation based on the BCE loss function, the third loss function, the second contrastive learning loss function, and the first contrastive learning loss function, to obtain the target super-resolution network.

19. The non-transitory computer-readable storage medium according to claim 11, wherein a process of generating the negative sample image comprises:
up-sampling the input sample image to obtain a candidate sample image with the same size as the positive sample image;
determining a first weight corresponding to the candidate sample image, and determining a second weight corresponding to the positive sample image;
summing a first product of the candidate sample image and the first weight and a second product of the positive sample image and the second weight to obtain a fused image; and
adding Gaussian random noise to the fused image to generate the negative sample image.

20. The non-transitory computer-readable storage medium according to claim 11, wherein the determining a second contrastive learning loss function based on the fourth feature, the fifth feature, and the sixth feature comprises:
determining a fourth loss function based on the fourth feature and the sixth feature;
determining a fifth loss function based on the fifth feature and the sixth feature; and
determining the second contrastive learning loss function based on the fourth loss function and the fifth loss function.

21. The non-transitory computer-readable storage medium according to claim 20, wherein the determining the second contrastive learning loss function based on the fourth loss function and the fifth loss function comprises:
calculating a ratio of the fourth loss function to the fifth loss function to obtain the second contrastive learning loss function, wherein the fourth loss function is an L1 loss function representing a mean absolute error between the fourth feature and the sixth feature, and the fifth loss function is an L1 loss function representing a mean absolute error between the fifth feature and the sixth feature.
